(19) United States
(12) Patent Application Publication
(10) Pub. No.: US 2013/0251482 A1
(43) Pub. Date: Sep. 26, 2013

(54) POSITIONING CONVEYOR, WAREHOUSE SYSTEM, AND METHOD FOR RECEIVING PIECE GOODS FROM A CONVEYOR

(71) Applicant: SSI SCHAEFER NOELL GMBH LAGER- UND SYSTEMTECHNIK, (US)

(72) Inventor: Elmar Issing, Giebelstadt (DE)

(21) Appl. No.: 13/783,945

(22) Filed: Mar. 4, 2013

Related U.S. Application Data
(63) Continuation of application No. PCT/EP2011/059629, filed on Jun. 9, 2011.

(30) Foreign Application Priority Data
Jun. 9, 2011 (DE) 10 2010 044 615

(51) Int. Cl. B65G 43/08; B65G 13/02; B65G 1/06

(52) U.S. Cl. CPC B65G 43/08; B65G 1/06; B65G 13/02
USPC 414/281; 198/781.05; 198/617; 414/800

(57) ABSTRACT

A positioning conveyor including an input section and a receiving section. The input and receiving sections define a conveyor line along which piece goods can be transported. The input section includes a length measuring device for measuring a length of a piece good which is to be received from a load-handling device of a storage and retrieval device and which is to be delivered to a rack. The receiving section includes a location-detector pair that defines a receiving location on the positioning conveyor and includes a first location detector and a second location detector. The detectors are spaced apart such that a conveying velocity of the conveyor line, after the upstream detector has detected a leading edge of the piece good, can be reduced so that the piece good, as soon as the leading edge is detected by a downstream detector, is immediately stopped at the downstream detector.

### RELATED APPLICATIONS

This is a continuation application of the co-pending international application WO 2012/028347 A1 (PCT/EP2011/059629) filed on Jun. 9, 2011, and claiming priority of the German patent application DE 10 2010 044 615 A1, filed on Sep. 2, 2010, both documents being fully incorporated herewith by reference.

### BACKGROUND OF THE INVENTION

The present invention relates to a positioning conveyor to be used as feeding conveyor of a serving device, in particular of a storage and retrieval device, which can travel adjacently relative to and along the positioning conveyor for receiving a piece good from an arbitrary receiving position on the positioning conveyor for the purpose of storing same into a rack. The invention further relates to a warehouse system having such a positioning conveyor. In addition, the present invention relates to a method for receiving piece good from a positioning conveyor by means of a load-handling device of a conveying unit, which is moveable in parallel to the positioning conveyor.

### RELATED PRIOR ART

A conventional article warehouse system and a control method of a storage and retrieval device (hereinafter shortly “SRD”) is disclosed in the European patent EP 1 897 822 B1. A rail-bound SRD can travel along a travel rail between two racks. The racks define a rack aisle therebetween, in which the SRD travels. So-called handing-over locations are located at one or both front faces of the rack aisle, where the SRD retrieves and delivers articles which are to be stored and to be retrieved. For example, the handing-over location is a fixedly defined region of a belt conveyor, wherein the fixedly defined region is preferably located at an end of the belt conveyor being arranged oppositely to the front face of the racks. Also, two parallel belt conveyors can be provided so that the SRD can store and retrieve articles at both sides of the rack aisle, wherein a, in this case first, handing-over location is arranged oppositely to a second handing-over location on the other belt conveyor. Further, a variation is described, wherein two handing-over locations arranged side-by-side, in particular receiving locations, are disclosed, from where articles are received by the SRD in order to store the received articles into the rack. For positioning the to-be-stored articles at the receiving location, a stopping element is used, against which a to-be-stored article is conveyed, and thereby stopped. Alternatively, an article sensor is provided at the receiving location, the article sensor halting the belt conveyor as soon as the to-be-stored article is detected by the article sensor at the handing-over location.

The positioning of a to-be-stored article is difficult in the light of an accuracy preset by the SRD. The SRD, i.e. in particular the load-handling device (shortly “LHD”) of the SRD, is to be positioned within a very small tolerance range (e.g. ±10 mm) relative to the handing-over location, i.e. relative to the actual position of the to-be-stored article at the time of receipt by the LHD, thereby allowing reliable receipt of the to-be-stored article from a (belt) conveyor by means of a load-handling device of the SRD. Already very small deviations during the positioning between the SRD and the actual location of the to-be-stored article can cause the LHD to not grasp the to-be-stored article correctly so that the to-be-stored article is either damaged, not received, or dropped.

Of course, the above-described utilization of the stopping element represents a reliable solution with regard to positioning accuracy, because the to-be-stored articles are always provided exactly at the location of the stopping element for being received by the LHD of the SRD, in particular if the conveyor is operated continuously so that the to-be-stored article is pressed continuously against the stopping element. However, the stopping element has the disadvantage that no articles can be transported behind the stopping element, i.e. downstream relative to the stopping element. The stationary stopping element, in this sense, only allows definition of one single handing-over location, which is spatially fixed, if the to-be-stored articles are provided by a (steady) conveyor.

Of course, several stopping elements could be arranged one behind the other along the conveyor by forming the stopping elements moveably, for example by rotating the stopping elements into the conveyor line. However, such stopping elements would have a bad positioning accuracy, just because of their movability, so that the actual advantageous positioning accuracy of a stationary stopping element would just get lost.

The above-discussed alternative solution, namely providing an article sensor at the location of the handing-over location, which stops the conveyor as soon as a to-be-stored article reaches the handing-over location, is also not sufficient with regard to positioning accuracy. In this case, contrary boundary conditions exist, which prevent the required positioning accuracy. One of the boundary conditions is a high conveying velocity as long as the to-be-stored article is transported towards the handing-over location, in order to allow supply of as many as possible to-be-stored articles within a time unit to the SRD. The higher this general conveying velocity is, the more inaccurate the positioning will become, if the to-be-stored article is decelerated by the article sensor. The conveying velocity is reduced to zero only if the to-be-stored article is detected. This reduction process, however, requires a certain time during which the to-be-stored article is trans-ported further, i.e. beyond the actual stopping point. Of course, it would be possible to consider this delay by moving the stopping point correspondingly upstream. However, this adaption is only possible in case when the to-be-stored articles always have the same weight, and in particular an identical size. Only in this case, the inertia effect can be reliably compensated in accordance with the just described manner. Typically, however, the different articles, or piece goods, are stored, which respectively have different sizes and weights. Even orientation of the article (e.g., standing on the head, lying on the side, oblique orientation, etc.) can affect a length of a “braking distance”.

Another disadvantage of the just discussed solution is to be further seen in that the conveyor cannot supply additional articles if the conveyor is stopped for the purpose of stopping an article located the farthest downstream.

Recently attempts were made to turn away from the above-described concept of feeding to-be-stored piece goods at the front face. The inventors of the present invention have recognized that it is advantageous to feed the piece goods over an entire length of the storing region, instead of only at the front face which is relatively short compared thereto. Another advantage is to be seen in that, for example, multiple SRD within the same aisle can simultaneously receive to-be-stored piece goods. Storing paths of the SRD can be shortened since the SRD do not need to be moved to the front face of the storage region for receiving the to-be-stored piece good. Thereby, changing time is reduced, i.e. the time required for moving the SRD to the receiving location, fine positioning of the SRD relative to the receiving location, receiving the to-be-stored piece good by means of the LHD, moving the SRD to the storage location, and delivering the received piece good to the storage location.

### SUMMARY OF THE INVENTION

Therefore, it is an object of the present invention to provide a positioning conveyor allowing delivery of a plurality of different piece goods having different sizes, orientations, weights, etc. at a plurality of different receiving positions along an entire length of the positioning conveyor for the purpose of receiving same by means of an LHD of a conveying unit in a position-accurate manner, i.e. at a tolerance of, for example, ±10 mm. In particular, warehouse systems having such a positioning conveyor are to be provided. Further, it is an object of the invention to provide a method for delivering a to-be-stored piece good in a position-accurate manner.

According to a first aspect of the invention it is disclosed a positioning conveyor comprising a positioning conveyor to be used as a feeding conveyor of a storage and retrieval device which can travel adjacently to and along the positioning conveyor, in order to receive a piece good from a predetermined receiving position on the positioning conveyor for the purpose of storing same into a rack, the positioning conveyor comprising an input section and a receiving section, which is located downstream thereto in a conveying direction, wherein the input section and the receiving section define a conveyor line along which different piece goods can be transported downstream, wherein the input section preferably comprises a piece-good length measuring device for measuring a length of a piece good which is to be received from the positioning conveyor by means of a load-handling device of the storage and retrieval device and which is to be delivered into the rack, and wherein the receiving section comprises at least one location-detector pair, wherein each of the location-detector pairs defines a receiving location on the positioning conveyor, and further comprises a first location detector and a second location detector, which in turn are arranged at a distance to each other such that a conveying velocity of the conveyor line, after a first upstream location detector of a target receiving location has detected a leading edge of the piece good, can be reduced so that the piece good, as soon as the leading edge is detected by a downstream located second location detector of the target receiving location, is immediately stopped at the second location detector.

According to a second aspect of the invention it is disclosed, in a warehouse system having a storage and retrieval device, which has a load-handling device, a positioning conveyor for feeding piece goods to the storage and retrieval device, the positioning conveyor comprising: a conveying line for conveying the pieces goods downstream along a conveying direction, wherein each of the piece goods has leading and trailing edges, and wherein one of the piece goods is to be received from the positioning conveyor by means of the load-handling device of the storage and retrieval device at a target receiving position; a control device; and at least one location-detector pair; the conveying line including an input section and a receiving section, the receiving section being located downstream to the input section in the conveying direction; the receiving section comprising the at least one location-detector pair, each of the location-detector pairs defining a separate receiving position, and each of the location-detector pairs comprising an upstream first location detector and a downstream second location detector, the first and second location detectors being arranged at a first distance to each other; the control device being connected to each of the location-detector pairs for exchanging signals, the control device comprising a conveying-velocity controller, which is configured, under knowledge of the first distance between the first and second location detector of the target receiving position, to reduce the conveying velocity after the first location detector of a target location-detector pair, which corresponds to the target receiving position, has detected the leading edge of the to-be-received piece good, and to immediately stop the to-be-received piece good, by reducing the conveying velocity to zero, as soon as the leading edge is detected by the second location detector of the target location-detector pair.

Thus, in accordance with the invention multiple receiving locations are distributed, one behind the other and/or in an overlapping manner, over an overall length of the positioning conveyor, so that a conveying unit such as an SRD can receive a to-be-stored piece good in a path-optimized manner at a plurality of different receiving locations. The paths of the SRD can be shortened, which need to be covered by the SRD for retrieving from the positioning conveyor a piece good which is to be stored next.

By providing two location detectors for each location-detector pair, the conveying velocity can be reduced step by step from a first medium main conveying velocity, at which the positioning conveyor is substantially operated during a delivery process, to a lower second conveying velocity (“creep speed”), before the second conveying velocity is set to zero completely, in order to finally stop the to-be-stored piece good. The second conveying velocity is reduced to zero if a leading edge of the to-be-stored piece good arrives at the downstream located second location detector of the location-detector pair. Since the second conveying velocity is much smaller than the first (main) conveying velocity, inertia effects do almost not have any effect in terms of a “braking distance”, which causes movement of the to-be-stored piece good beyond the position of the second location detector. Thus, it is possible to stop a to-be-stored piece good, i.e. to achieve standstill, within a preset tolerance such as ±10 mm at the position of the second location detector.

Since the to-be-stored piece good is then stopped at a fixedly predetermined position, fine positioning of the conveying unit is no longer required. Typically, the conveying unit performs a fine positioning process after arrival at a coarse position by determining, by means of a suitable sensor unit, a still existing actual distance between the actual position of the to-be-stored piece good and the position of the LHD. This fine positioning process requires on the one hand additional equipment, which in turn increases the investment costs, and on the other hand time, which increases cycle time and thus reduces the throughput, or the performance, of the conveying unit.

With a preferred embodiment the positioning conveyor further comprises a control device which is connected to the length-measuring device and/or the location-detector pairs in order to transmit signals, and preferably comprises a conveying-velocity controller which is configured to reduce, in knowledge of a distance between first and second location detectors of the target-receiving location, the conveying velocity so that the piece good stops within the tolerance at the time of arriving at the second location detector of the target-receiving location.

The course of velocity between the different conveying velocity steps can be preset fixedly. In this case, a conveying velocity controller is superfluous. The transitions and the course of the conveying velocity transitions, however, can also be formed variably, for example, dependent on the weight of the to-be-stored piece good by utilizing a conveying-velocity controller which adapts the height and the course of the conveying-velocity steps correspondingly, if the conveying velocity is reduced to zero.

Further, it is preferred to operate the control device of the conveyor line at a freely adjustable, preferably constant, first conveying velocity until the piece good has arrived at the first location detector of the destination-receiving position, and then, at least within a close range of the destination-receiving position, at a second conveying velocity which is (significantly) smaller than the first conveying velocity.

With this embodiment different regions of the conveyor line can be operated at different velocities. In dependence on a length of the to-be-stored piece good regions of the conveying line, which are at least as long as the piece good which is to be stored, are operated at different velocities. The conveying device of the positioning conveyor, in particular spatially upstream relative to a destination-receiving position, can be operated in such a close range at the second conveying velocity. The to-be-stored piece good thus approaches the first location detector, for example, at the first conveying velocity. As soon as the leading edge of the to-be-stored piece good has arrived at the first location detector, the conveyor line, i.e. within the close range, is operated at the second conveying velocity, i.e. also conveyor-line regions located upstream relative to the first location detector are operated at the second conveying velocity. This can be realized in particular by using driven motor rollers. In this case, each of the motor rollers can be driven at a different conveying velocity. The control determines the number of motor rollers required for transporting the to-be-stored piece good. A corresponding number of motor rollers, which are located beneath the to-be-stored piece good, are either operated at the first conveying velocity, or later at the second conveying velocity. Other conveyor rollers, which are located outside of this group of motor rollers, can be operated at a different third conveying velocity that is greater or smaller than the first or the second conveying velocities.

Thus, if a number of to-be-stored piece goods are located on the positioning conveyor and are transported downstream, all of the piece goods might be trans-ported (theoretically) at a respectively different conveying velocity. Typically, the piece goods are transported, however, at a unitary main conveying velocity along the positioning conveyors. Only within the close range of a target receiving position the velocity is reduced, and is reduced to zero upon arrival at the second location detector.

It is possible to avoid piece-good jams on the positioning conveyor. For example, if the SRD has not yet reached the target receiving position, the conveying velocities of piece goods can be reduced, which are conveyed upstream relative to the piece good which is just to be stored and which might be stopped.

Further, it is advantageous to form and arrange a conveying device of the positioning conveyor such that the piece good is moved transversely relative to the conveying direction towards an edge of the positioning conveyors, which faces away from the storage and retrieval device.

If the to-be-stored piece goods are not fed to the positioning conveyor in an already orientated manner, then the inclination of the conveying means of the positioning conveyor allows orientation along a lateral edge of the positioning conveyor. This facilitates the receiving process of the SRD. In the view of the SRD, in this case a trailing edge of the piece good is always located at a predetermined fixed depth. Thus, the LHD of the SRD always needs to be extracted correspondingly deep, in order to grasp the to-be-stored piece good reliably.

Also, it is preferred to arrange a guiding device at the edge, which extends along the conveying direction, which prevents that the piece good is laterally conveyed off the positioning conveyor, and which ensures that the piece good always remains constantly orientated along a direction perpendicular to the conveying direction.

For example, the guiding device can be implemented by sheet metal, which is arranged perpendicular to a conveying plane at a lateral edge of the positioning conveyor. By inclining the conveying device of the positioning conveyor the to-be-stored piece goods are conveyed against this sheet metal. The sheet metal prevents the correspondingly orientated piece goods from falling off the positioning conveyor. The sheet metal represents kind of a stop that in turn has an effect on a grasping depth of the LHD of the SRD, as explained above.

With another particular embodiment, preferably only, individual drivable rollers are used as the conveying device. The axes of rotation of these rollers are preferably orientated obliquely relative to the conveying direction so that the piece good can be transported along the receiving section substantially in parallel relative to the conveying direction and slightly transverse thereto.

The advantage of the rollers is that they can be specifically controlled, wherein the individual conveying velocities can be varied continuously. It is clear that single-driven rollers can also be connected to idle rollers via connecting means such as elastic belts, in order to form conveying-roller segments, all of which are then operated at the conveying velocity of the driven roller.

With another particular embodiment the location detectors are light sensors or light barriers, which are preferably arranged between adjacent rollers.

It is clear that beside light sensors and light barriers other sensors can be utilized which respond, for example, to weight, contact, heat, etc. Supersonic and infrared sensors can be utilized for detecting whether or not, and when, a to-be-stored piece good has arrived at a predetermined position on the positioning conveyor. The light sensors and the light barriers are particularly advantageous because they can be integrated into interstices between adjacent ones of the rollers. The light sensors or the light barriers do not disturb the basic structure of the conveyor. The light sensors or the light barriers can be connected directly to the control module of the motor rollers, in order to influence the conveying velocity thereof when a to-be-stored piece good is detected.

In particular, a distance between directly adjacent location-detector pairs is constant. The distance between adjacent location-detector pairs defines a maximum length of a to-be-stored piece good, which can be stopped at a target receiving position. It is clear that multiple receiving positions can be connected logically with each other to form a unit, wherein the location-detector pair being arranged the farthest downstream supplies the signals for reducing the velocity in accordance with the above-described manner. The length of one of the to-be-stored piece goods can either be determined in the input section by means of an optionally provided piece-good length measuring device or, alternatively must already have been provided in terms of known data so that a control device, which is assigned to the positioning conveyor, can take corresponding measures for logically concentrating sufficient location-detector pairs, in order to logically combine piece goods having overlengths, i.e. lengths being greater than a normal maximum length of one receiving position.

Preferably, a distance between the first and second location detectors of each of the location-detector pairs is constant. Particularly, this distance in turn corresponds to the distance between directly adjacent location-detector pairs.

This means, if rollers are exemplarily used as the conveying means, that location detectors can be provided between, for example, all of the adjacent rollers for defining location-detector pairs, which are continuously arranged in a distributed manner one after the other over an overall length of the positioning conveyor. Dependent on the diameter of the utilized rollers, almost at any arbitrary position of the conveyor a receiving position can be defined so that a superordinated control device (e.g. central computer, warehouse management computer, material flow computer, etc.) can cause a receipt of a to-be-stored conveying good at practically any arbitrary position of the positioning conveyor. Thereby, the paths, which need to be travelled by the conveying units, are additionally reduced so that the total performance is increased.

With another preferred embodiment the length-measuring device comprises a measuring grid, which is adapted to determine a length of the piece good in the conveying direction and a width of the piece good perpendicular to the conveying direction.

The length-measuring device can also determine both the length and the width of the to-be-stored piece good, before the to-be-stored piece good is conveyed further to the receiving section. This determination can either happen in the input section or at a position, which is located still further upstream relative to the positioning conveyor.

According to a third aspect of the invention it is disclosed a warehouse system having a positioning conveyor according to the invention, a storage and retrieval device, and a rack, wherein the storage and retrieval device is arranged between the positioning conveyor and the rack so that a load-handling device of the storage and retrieval device can receive a piece good at a target-receiving position without the need of performing fine positioning between the positioning conveyor and the storage and retrieval device by means of a corresponding sensor before the piece good is received.

According to a fourth aspect of the invention it is disclosed a warehouse system comprising: a positioning conveyor; a storage and retrieval device; and a rack; wherein the storage and retrieval device has a load-handling device and is arranged between the positioning conveyor and the rack so that the load-handling device of the storage and retrieval device can receive a piece good at a target-receiving position from the positioning conveyor without fine positioning between the positioning conveyor and the storage and retrieval device, wherein the positioning conveyor comprises: a conveying line for conveying the pieces goods downstream along a conveying direction, wherein each of the piece goods has leading and trailing edges, and wherein one of the piece goods is to be received from the positioning conveyor by means of the load-handling device of the storage and retrieval device; a control device; and at least one location-detector pair; the conveying line comprising an input section and a receiving section, the receiving section being located downstream to the input section in the conveying direction; the receiving section comprising the at least one location-detector pair, each of the location-detector pairs defining a separate receiving position, and each of the location-detector pairs comprising an upstream first location detector and a downstream second location detector, the first and second location detectors being arranged at a first distance to each other; and the control device being connected to each of the location-detector pairs for exchanging signals, the control device comprising a conveying-velocity controller, which is configured, under knowledge of the first distance between the first and second location detector of a target receiving location, to reduce the conveying velocity after the first location detector of a target location-detector pair, which corresponds to a target receiving position, has detected the leading edge of the to-be-received piece good, and to immediately stop the to-be-received piece good as soon as the leading edge is detected by the second location detector of the target location-detector pair.

Preferably a piece-good orienting unit is arranged upstream to the positioning conveyor, in order to orientate piece goods, which are handed over by the piece-good orienting unit to the positioning conveyor, at a lateral edge, which is part of both the positioning conveyor and the piece-good orienting unit.

If the conveying device of the positioning conveyor is not formed obliquely, i.e. if the to-be-transported piece goods are only transported in parallel relative to the main conveying direction of the positioning conveyor, it could happen that the piece goods are transported over the positioning conveyor at a lateral displacement relative to each other. This makes the receiving process more difficult, since the SRD, without additional sensors, does not have any knowledge of the “depth” of the piece good, which is currently to be received, relative to the conveyor line. Therefore, it can be advantageous to arrange a piece-good orientating unit such as a rotating plate, a matrix conveyor, or the like, upstream relative to the positioning conveyor, in order to rotate piece goods, for example, about an axis perpendicular to the conveying plane into a predetermined orientation (e.g., longitudinal side of the piece good always parallel to the conveying direction) and/or to position the piece goods at a lateral edge, which then fades into the edge of the adjacently arranged positioning conveyor in a downstream direction.

According to a fifth aspect of the invention it is disclosed a method for receiving a piece good from a positioning conveyor by means of a load-handling device of a conveying unit comprising the steps of: conveying the piece good downstream along a conveying direction to a target-receiving position at a first conveying velocity; detecting a leading edge of the piece good by means of a first location detector of a location-detector pair, which defines the target-receiving position, wherein the first location detector is arranged at a distance upstream relative to a second location detector of the location-detector pair; if the first location detector has detected the leading edge, reducing the first conveying velocity, at least within a close range of the target-receiving position, to a smaller second conveying velocity so that the second conveying velocity, as soon as the leading edge is detected by the second location detector, is immediately reduced to zero so that the piece good stops at the second location detector.

According to a sixth aspect of the invention it is disclosed a method for receiving a piece good from a positioning conveyor by means of a load-handling device of a conveying unit comprising the steps of: conveying the piece good downstream along a conveying direction to a target-receiving position at a first conveying velocity; detecting a leading edge of the piece good by means of a first location detector of a location-detector pair, which defines a target-receiving position, wherein the first location detector is arranged at a first distance upstream relative to a second location detector of the location-detector pair; if the first location detector has detected the leading edge, reducing the first conveying velocity, at least within a close range of the target-receiving position, to a smaller second conveying velocity so that the second conveying velocity, as soon as the leading edge is detected by the second location detector, is immediately reduced further to zero so that the piece good stops at the second location detector.

Further, it is preferred if the conveying unit is moved to a position directly opposite to the receiving position so that a load-handling device of the conveying unit, in particular in knowledge of the lengths of the piece goods, is positioned and moved so that the piece good is directly received by the positioning conveyor without additional fine positioning of the conveying unit.

### BRIEF DESCRIPTION OF THE DRAWINGS

It is clear that the above-mentioned and still to be explained features cannot be used in the respectively given combination only but also in other combinations, or alone, without departing from the scope of the present invention.

Embodiments of the invention are illustrated in the drawings and will be explained in more detail in the description below, wherein:

FIG. 1 shows a top view of a warehouse system having a positioning conveyor in accordance with the present invention;

FIG. 2 shows a top view of another embodiment of a positioning conveyor in accordance with of the present invention;

FIG. 3 shows an enlargement of a section of FIG. 2; and

FIG. 4 shows a flow chart of a method in accordance with the present invention.

### PREFERRED EMBODIMENTS OF THE INVENTION

In the following description of the figures identical features will be designated by identical reference numerals. Similar features will be provided with similar reference numerals. If the embodiments are different, the differences will be explained explicitly. Position information such as top, bottom, left, right, and the like, are related to the described figures, but are not to be interpreted restrictively, i.e. if a position of an object, which is to be described, is changed (e.g., rotated about 90°) the position information is to be adapted correspondingly (e.g., “horizontal” will become “vertical”, and vice versa).

Before the figures will be described in detail, hereinafter some terms will be explained in general. Storage and retrieval devices (SRD) are ground-bound conveying units that travel, for example, along a rack, in particular within an aisle between two adjacent racks, most times being rail-guided. The SRD comprise a travel unit, one or more masts, a hoist unit, and a load-handling device (LHD). The LHD is a mechanical unit that receives and delivers storage units, i.e. piece goods such as pallets, containers, cartons, or the like. A typical pallet LHD is, for example, a lifting fork (which is moveable in a telescopic manner). SRD are used for handling pallets, wherein the SRD can have masts up to 55 m high.

Parameters such as velocity and acceleration/deceleration are adjusted variably through a control of the SRD for regulating the SRD in a load-dependent manner, in order to reduce energy consumption and mechanical wear. In addition, high throughput, i.e. high performance with regard to exchange of loads, are to be achieved. The throughput is particularly high if the SRD travels at high velocities within the rack aisles. For this purpose, it is necessary that a sufficient number of to-be-stored piece goods be provided in time so that feeding conveyors are also operated, preferably, at a high average velocity.

A conveyor is a device for transporting piece goods (e.g. pallets, boxes, packages, cartons, trays, containers, etc.). A conveyor is to be understood, in a first step, as a mechanical unit. In-company transport systems are considered as part of the conveyors such as steady conveyors. The conveyors comprise substantially all technical and organizational devices for moving or transporting goods and people. The conveying good is transported most times in a steady flow from one or more deposition positions (sources) to one or more delivery positions (targets), for example, by means of belt conveyors, roller conveyors, chain conveyors, circle conveyors, overhead conveyors, and similar conveyor types. Particular features of a steady conveyor are: a continuous, or discrete-continuous, stream of conveying goods; loading and unloading during operation; steady readiness for receiving/delivering; as well as a stationary-fixed device. The continuous operation allows the transportation of relatively huge quantities in short time. The throughput of piece-good conveyors is calculated in terms of quotient of a conveying velocity and an average piece-good distance. In contrast, unsteady conveyors are operated in the so-called suspend-mode. In this context, the transport is performed by several individual movements (such as start-up, lowering, lifting, and the like), which occur temporarily one behind the other, and partially also simultaneous. One example of an unsteady conveyor is a forklift truck, or a crane.

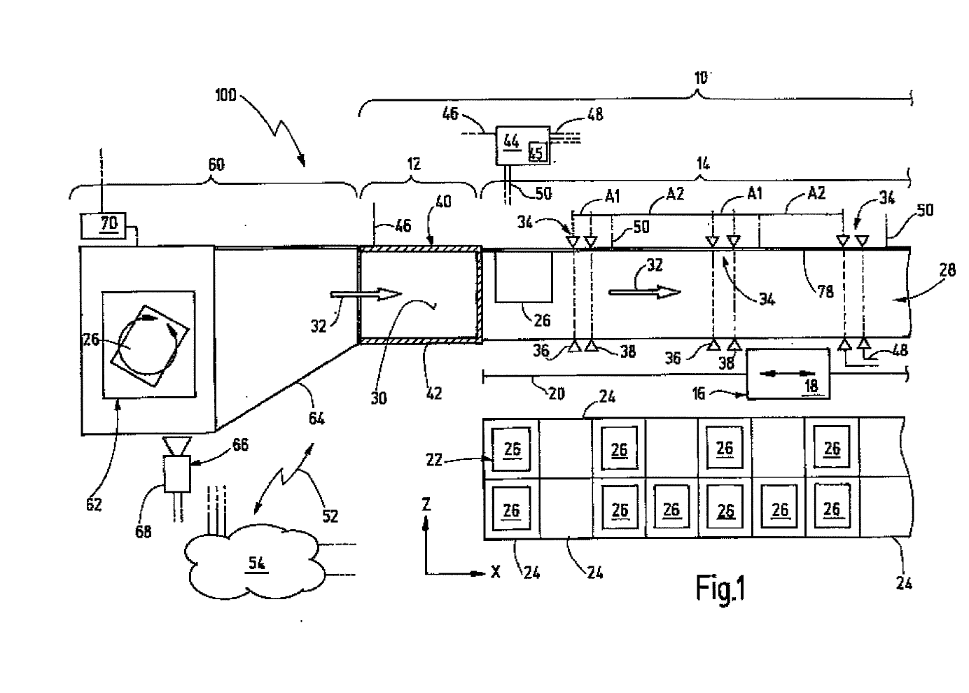

With reference to FIG. 1 a warehouse system 100 is shown comprising a positioning conveyor 10. The positioning conveyor 10 can be used, for example, in a system as described in the German patent application DE 10 2010 010 433.

The positioning conveyor 10 comprises an input section 12 and a receiving section 14 located adjacently downstream thereto. A conveying unit 16 is arranged in parallel to the positioning conveyor 10, the conveying unit 16 being exemplarily implemented in terms of an SRD 18. The SRD 18 can travel along a travel rail 20. A storage region is arranged oppositely relative to the positioning conveyor 10 and is oriented in parallel, such as a rack 22. It is clear that the positioning conveyor 10 can extend in parallel beneath, above, or within the rack 22. The rack 22 comprises a plurality of (rack) storage locations 24, which can be provided one above the other on several levels. The SRD 18 can move both in a horizontal direction (direction X) and in a vertical direction (direction Y), i.e. perpendicular relative to the drawing plane of FIG. 1. It is clear that other conveying units 16, such as transfer trolleys, which is not shown here, can be used, which can be moveable in one spatial direction only, for example. Transfer trolleys typically comprise no lifting functionality, and therefore, in most cases, can only be moved in the horizontal direction. As an alternative to the SRD 18, for example, a lifting bar having a trolley, which is supported displaceable in a horizontal direction, can be used as the conveying unit 16. Also, moveable or stationary (grasping) robots (not shown), or the like, can be used.

The positioning conveyor 10 comprises a conveyor line 28, which moves piece goods 26 in a (main) conveying direction 32 and defines a conveying plane 30. It is clear that the conveyor line 28 can comprise upward and downward slopes for bridging height differences. The piece goods 26 can be transported on the conveyor line 28, or the conveying plane 30, in the conveying direction 32, as illustrated by means of dark arrows in FIG. 1.

Hence, piece goods 26 are transported towards the SRD 18 over the conveyor line 28, the SRD 18 receiving the piece good 26 delivered from the conveyor line 28 by means of an LHD, which is not shown in more detail here, the LHD moving the piece goods 26 onto the SRD 18, wherein the SRD 18 moves to an empty storage location 24 and then delivers the received piece good 26 to the storage location 24 by means of the LHD. It is clear that the LHD can be formed to be operated multiple deep, i.e. so that the LHD can reach deeper into the rack 22 than by one of the storage locations 24, in order to reach a second row of storage locations 24 being arranged behind a first row of storage locations, wherein the first row of storage location is arranged directly adjacent to a rack aisle in which the SRD 18 is moved in the horizontal and/or vertical direction(s).

The positioning conveyor 10 comprises at least one location-detector pair 34 in the receiving section 14, where the SRD 18 receives to-be-stored piece goods 26. Each of the location-detector pairs 34 includes at least two location detectors 36 and 38. A first location detector 36 is located upstream relative to additional location detectors, in the present case relative to a second location detector 38 of the same location-detector pair 34. Additional location detectors, if present, are located further downstream relative to the second location detector 38 (not shown in FIG. 1). For each of the location-detector pairs 34 the first location detector 36 is arranged at a distance A1 relative to the second location detector 38. The distances A1 can vary in size from pair 34 to pair 34. Adjacent location-detector pairs 34 have a distance A2 relative to each other. Preferably, the distances A1 between first and second location detectors 36 and 38 are identical for all of the location-detector pairs 34. The same applies with respect to the distance A2 between adjacent location-detector pairs 34. In particular, the distances A1 and A2 can be identical. The distance A1 is preferably selected in dependence on an average conveying velocity of the positioning conveyor 10. The higher the average conveying velocity is, the greater the distance A1 should be.

The input section 12 of the positioning conveyor 10 receives to-be-stored piece goods 26 and delivers it in the conveying direction 32 to the adjacent receiving section 14. The input section 12 and the receiving section 14 can be implemented in terms of separate conveyors. Separate embodiment of the conveying sections is particularly advantageous if the input section 12 comprises a length-measuring device 40 such as a light grid 42, in order to determine a geometrical length L of one to-be-stored conveying good 26 in parallel relative to the conveying direction 32. Dependent on the embodiment of the length-measuring device 40, also a width B of the conveying good (perpendicular to the conveying direction 32) can be determined additionally. Knowledge of the length L and the width B is of interest to a LHD of the SRD 18, the LHD can be adjusted upon knowledge of the length L and the width B so that grasping elements of the LHD can be moved sufficiently far away from each other and/or can be extracted sufficiently deep for reliably receiving the to-be-stored piece good 26, without damaging the piece good 26, or losing same.

Further, a control device 44 of the positioning conveyor 10 is shown in FIG. 1. The control device 44 can be implemented in terms of a stored-program controller (SPC), and can optionally be provided with a conveying-velocity controller 45, which is either implemented in terms of hardware and/or in terms of software. The conveying-velocity controller 45 allows changing the conveying velocities arbitrarily, as will be explained in more detail below.

The control device 44 can be connected to the length-measuring device 40 through a signal connection 46, if the length-measuring device 40 is present at all. The control device 44 can be connected to the location-detector pairs 34 through signal connections 48. The control device 44 can be connected to one or more conveying devices via signal connections 50, the conveying devices defining the conveyor line 28. The control device 44 can also be connected to a superordinated control 54 such as a central computer, a warehouse management computer, or a material flow computer via a signal connection 52. The signal connections 46 through 50 are exemplarily implemented in terms of solid lines. The signal connection 52 is exemplarily implemented in terms of wireless connection. It is clear that each of the connections can be implemented solid or wireless.

The warehouse system 100 of FIG. 1 can further comprise a piece-good orientating unit 60, which in turn can comprise a rotating device 62 and, optionally, an intermediate conveyor 64. The rotating device 62 is presently shown, for example, in terms of a rotating plate by which to-be-stored piece goods 26 can be rotated about an axis and then be orientated, the axis being perpendicular to the conveying plane 30. The intermediate conveyor 64 can be implemented by an oblique conveyor, which conveys the piece good 26 towards a lateral edge located in the upper part of FIG. 1, the lateral edge fading into a corresponding upper lateral edge 77 of the positioning conveyor 10. The rotating device 62 can comprise an image-generating device 66 such as a video camera 68, which is preferably arranged upstream relative to the rotating device 62 for allowing recognition in advance, by means of suitable image processing algorithms, whether or not one of the piece goods 26 needs to be rotated. Rotation can be required, for example, if a longitudinal side of the piece good 26 is broader than a width of the positioning conveyor 10. In this case, it is recommended to orientate the piece good 26 with its longitudinal side in parallel to the conveying direction 32 before this piece good 26 enters the positioning conveyor.

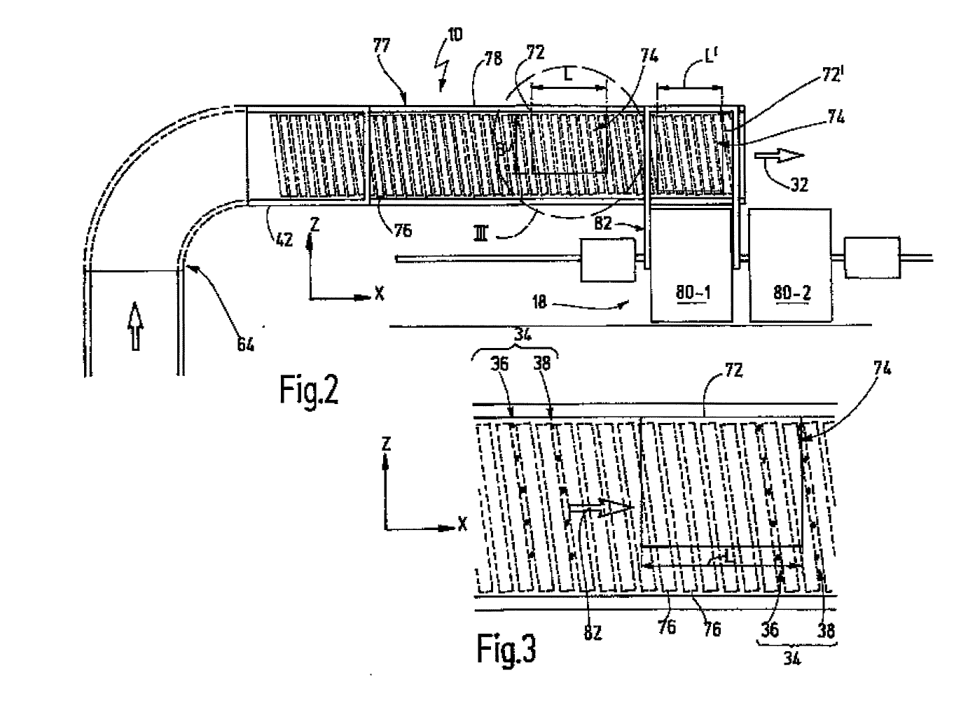

FIG. 2 shows a modified embodiment of a positioning conveyor 10. The positioning conveyor 10 of FIG. 2 comprises a plurality of rollers 76, some or all of which can be driven individually. Axes of the rollers 76 are slightly oriented obliquely relative to a transverse direction (direction Z) for conveying the piece goods 26 against the upper edge 77 in FIG. 2. A guiding device 78, e.g. in terms of a guiding sheet metal, is provided in the region of the edge 77, the guiding device being orientated perpendicular to the conveying plane 30. A driven perpendicular conveyor belt, or the like, could also realize the guiding device 78.

With reference to FIG. 3 an enlarged section of FIG. 2 is shown, which is surrounded by a circle in FIG. 2. FIG. 2 shows a receiving position 72, an attitude of which is determined relative to the conveyor line 28 by means of the guiding device 78 and the location detector 38, which is located the farthest downstream, of the associated location-detector pair 34. Each of the location-detector pairs 34 defines a separate receiving location 72.

The receiving location 72 shown in FIG. 3 corresponds, with regard to an area thereof, to one to-be-stored piece good 26 having a length L. It is clear that a length of the receiving location 72 can be selected almost arbitrarily. If the receiving location extends beyond a location-detector pair 34, then the concerned location-detector pairs 34 can be combined logically to form a unit. Maximum width of the receiving position 72 is determined by the width of the conveying device.

Light sensors are used in FIGS. 2 and 3 as first and second location detectors 36 and 38, which are exemplarily formed by a number of light sensors being connected one behind the other. The location detectors 36 and 38 are preferably arranged in spaces between the rollers 76. Thus, it is possible to arrange the location detectors 36 and 38, for example, beneath a conveying plane 30, thereby not disturbing the flow of piece goods on the conveyor line 28. It is clear that instead of the light sensors also light barriers, or the like, can be used, which are then preferably arranged laterally to the lateral edges of the conveyor line 28. Further, it is clear that any other arbitrary type of sensor (such as pressure sensors, contact sensors, supersonic sensors, infrared sensors, etc.) can be used as the location detectors.

Returning to FIG. 2 two different receiving positions 72 and 72′ are shown, which preferably correspond to a geometrical base area of the piece good 26 which is just to be stored. The receiving position 72′ differs from the receiving position 72, for example, in that the piece good 26 is rotated about 90°.

Further, a first LHD 80-1 and a second LHD 80-2 of the SRD 18 are exemplarily shown in FIG. 2. For the sake of a facilitated illustration only the first LHD 80-1 is depicted with a grasping unit 82, which, for example, comprises two grasping arms in order to allow movement of the to-be-stored piece good 26 onto the LHD 80-1.

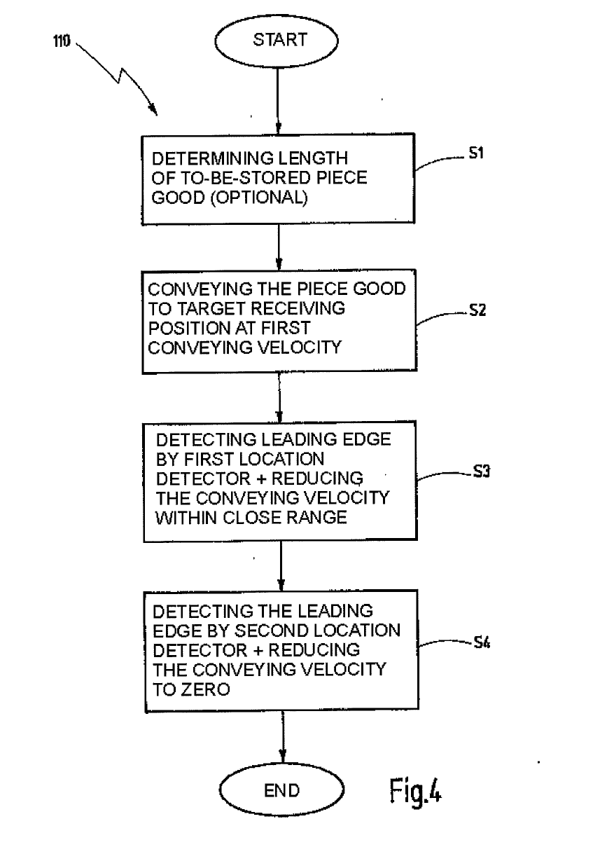

With reference to FIG. 4 a heavily schematized flow of a method 110 in accordance with the present invention is shown. It is clear that the above-given explanations with regard to the general procedure are assisting the explanation of the flow chart of FIG. 4.

In a first step S1 of the method 110 a length L of the to-be-stored piece good 26 can be determined optionally. In a second step S2 the piece good 26 is conveyed to a target-receiving position 72 at a first conveying velocity. As soon as the first location detector 36 detects a leading edge 74 of the to-be-stored piece good 26, the conveying velocity within the close range of the location detector pair 34 is reduced in step S3.

In step S4 the second location detector 38 detects the leading edge 74. As soon as the leading edge 74 is detected, the conveying velocity is reduced to zero so that the to-be-stored piece good 26 stops.

It is clear that reception can be accompanied simultaneously by delivery. This is finally dependent on the embodiment of the load-handling device of the serving unit. If the load-handling device is configured to handle multiple piece goods simultaneously, a first piece good can be received while a second piece good is delivered at the same time. Such receipt and delivery can occur between the serving unit and the storage location as well as between the serving unit and the positioning conveyor. The piece goods can be delivered and/or received simultaneously, namely side-by-side and/or on top of each other.

A serving unit can be provided not only in terms of a storage and retrieval device, but also in terms of a (grasping) robot, or a pushing device/pulling device, which in turn can be provided stationary, or moveably.

Therefore, what we claim is:

1. In a warehouse system having a storage and retrieval device, which has a load-handling device, a positioning conveyor for feeding piece goods to the storage and retrieval device, the positioning conveyor comprising:
a conveying line for conveying the pieces goods downstream along a conveying direction, wherein each of the piece goods has leading and trailing edges, and wherein one of the piece goods is to be received from the positioning conveyor by means of the load-handling device of the storage and retrieval device at a target receiving position;
a control device; and
at least one location-detector pair;
the conveying line including an input section and a receiving section, the receiving section being located downstream to the input section in the conveying direction;
the receiving section comprising the at least one location-detector pair, each of the location-detector pairs defining a separate receiving position, and each of the location-detector pairs comprising an upstream first location detector and a downstream second location detector, the first and second location detectors being arranged at a first distance to each other;
the control device being connected to each of the location-detector pairs for exchanging signals, the control device comprising a conveying-velocity controller, which is configured, under knowledge of the first distance between the first and second location detector of the target receiving position, to reduce the conveying velocity after the first location detector of a target location-detector pair, which corresponds to the target receiving position, has detected the leading edge of the to-be-received piece good, and to immediately stop the to-be-received piece good, by reducing the conveying velocity to zero, as soon as the leading edge is detected by the second location detector of the target location-detector pair.

2. The positioning conveyor of claim 1, wherein the input section comprises a piece-good length measuring device for measuring a length of the to-be-received piece good.

3. The positioning conveyor of claim 1, wherein the control device is configured to operate the conveyor line at a freely adjustable first conveying velocity until the to-be-received piece good has arrived at the first location detector of the target-receiving position, and then to operate the conveyor line at a second conveying velocity which is smaller than the first conveying velocity.

4. The positioning conveyor of claim 3, wherein the first conveying velocity is constant, and the conveyor line is operated at the second velocity when the to-be-received piece good enters a close range of the second location detector of the target receiving location.

5. The positioning conveyor of claim 1, wherein the conveyor line has two lateral edges, which extend in parallel to each other along the conveying direction, and a conveying device, which is formed and arranged such that the to-be-received piece good is moved transversely relative to the conveying direction towards one of the lateral edges of the positioning conveyor, which is facing away from the storage and retrieval device.

6. The positioning conveyor of claim 5, further comprising a guiding device being arranged at the one of the lateral edges and preventing the piece goods from being conveyed laterally off the positioning conveyor.

7. The positioning conveyor of claim 1, wherein the conveying line comprises a plurality of rollers, which are controllable individually.

8. The positioning conveyor of claim 7, wherein each of the rollers has an axis of rotation, the axes of rotation being orientated obliquely relative to the conveying direction so that the piece good is transported along the receiving section substantially in parallel relative to the conveying direction and slightly transversely thereto.

9. The positioning conveyor of claim 1, wherein the first and second location detectors respectively are one of light sensors and light barriers.

10. The positioning conveyor of claim 1, wherein the conveying line comprises a plurality of rollers, and wherein the first and second location detectors respectively are one of light sensors and light barriers which are arranged between adjacent ones of the rollers.

11. The positioning conveyor of claim 1, wherein directly adjacent location-detector pairs are arranged at a constant second distance relative to each other.

12. The positioning conveyor of claim 11, wherein the first distance is constant and corresponds to the second distance.

13. The positioning conveyor of claim 2, wherein the length-measuring device comprises a light grid formed such that a length is determined in the conveying direction and a width of the piece good is determined perpendicular relative to the conveying direction.

14. A warehouse system comprising: a positioning conveyor; a storage and retrieval device; and a rack; wherein the storage and retrieval device has a load-handling device and is arranged between the positioning conveyor and the rack so that the load-handling device of the storage and retrieval device can receive a piece good at a target-receiving position from the positioning conveyor without fine positioning between the positioning conveyor and the storage and retrieval device, wherein the positioning conveyor comprises: a conveying line for conveying the pieces goods downstream along a conveying direction, wherein each of the piece goods has leading and trailing edges, and wherein one of the piece goods is to be received from the positioning conveyor by means of the load-handling device of the storage and retrieval device; a control device; and at least one location-detector pair; the conveying line comprising an input section and a receiving section, the receiving section being located downstream to the input section in the conveying direction; the receiving section comprising the at least one location-detector pair, each of the location-detector pairs defining a separate receiving position, and each of the location-detector pairs comprising an upstream first location detector and a downstream second location detector, the first and second location detectors being arranged at a first distance to each other; and the control device being connected to each of the location-detector pairs for exchanging signals, the control device comprising a conveying-velocity controller, which is configured, under knowledge of the first distance between the first and second location detector of a target receiving location, to reduce the conveying velocity after the first location detector of a target location-detector pair, which corresponds to a target receiving position, has detected the leading edge of the to-be-received piece good, and to immediately stop the to-be-received piece good as soon as the leading edge is detected by the second location detector of the target location-detector pair.

14. The warehouse system of claim 13, wherein the positioning conveyor is located downstream relative to a piece-good orientating unit for orientating the piece goods, which are handed over by the piece-good orientating unit to the positioning conveyor, along a lateral edge, which is comprised in common by the positioning conveyor and the piece-good orientating unit.

15. A method for receiving a piece good from a positioning conveyor by means of a load-handling device of a conveying unit comprising the steps of:
conveying the piece good downstream along a conveying direction to a target-receiving position at a first conveying velocity;
detecting a leading edge of the piece good by means of a first location detector of a location-detector pair, which defines a target-receiving position, wherein the first location detector is arranged at a first distance upstream relative to a second location detector of the location-detector pair;
if the first location detector has detected the leading edge, reducing the first conveying velocity, at least within a close range of the target-receiving position, to a smaller second conveying velocity so that the second conveying velocity, as soon as the leading edge is detected by the second location detector, is immediately reduced further to zero so that the piece good stops at the second location detector.

16. The method of claim 15, wherein the conveying unit is moved to a position directly opposite to the target receiving position so that the load-handling device of the conveying unit is positioned and moved, under knowledge of the length of the piece good, such that the piece good is received directly from the positioning conveyor without additional fine positioning of the conveying unit.
